(19) United States
(12) Patent Application Publication
(10) Pub. No.: US 2006/0035627 A1
(43) Pub. Date: Feb. 16, 2006

(54) Wireless distribution-point content insertion

(76) Inventor: Mukesh Prasad, Windsor, CT (US)

Correspondence Address: Mukesh Prasad, 71 Lancaster Drive, Windsor, CT, 06095, US

(21) Appl. No.: 11/178,576

(22) Filed: Jul. 11, 2005

Related U.S. Application Data
(60) Provisional application No. 60/587,728, filed on Jul. 13, 2004.

(51) Int. Cl. H04Q 7/22; H04M 3/493

(52) U.S. Cl. 455/414.2

(57) ABSTRACT

A content-insertion module that allows a hot-spot owner to insert specific content in wireless messages. The inserted content can be internet version of the commonly seen “bumber sticker” messages. It can also be commercial in nature.

### RELATED APPLICATIONS

The present application is a continuation-in-part application of United States provisional patent application, Ser. No. 60/587,728, filed Jul. 15, 2004, included by reference herein and for which benefit of the priority date is hereby claimed.

The present application is related to United States patent number U.S. Pat. No. 6,421,717, issued Jul. 16, 2002, included by reference herein.

The present application is related to United States patent number U.S. Pat. No. 6,725,022, issued Apr. 20, 2004, included by reference herein.

The present application is related to United States patent number U.S. Pat. No. 6,587,837, issued Jul. 1, 2003, included by reference herein.

### FIELD OF THE INVENTION

The present invention relates to wireless modems and, more particularly, to web pages and related content served over wireless modems. The invention relates both to modems referred to as Wi-Fi and Wi-Max.

### BACKGROUND OF THE INVENTION

Wireless technology presents a certain proliferation of wireless distribution-points, commonly knows as “hot-spots”. The hot-spots have the property that the user group cannot be easily restricted, and users who are not intended target can easily share the hot-spot. Thus a solution that gives the hot-spot owner an advantage would be generally beneficial. The problem has existed for several years now, but a simple solution has thus far not been presented. A solution such as the one being described here, may also help wireless technology to take off better than it has so far.

Data encryption allows restricting the user group.

Data encryption makes usage of the hot-spot difficult for everybody, including the intended users, thus is not a very preferred solution.

It is therefore an object of the invention to allow wireless hot-spot owners the ability to insert content of their choice to those viewers that choose to use the owned hot-spot.

It is another object of the invention to let the hot-spot owners modify or delete the inserted conent as desired.

### SUMMARY OF THE INVENTION

In accordance with the present invention, there is provided a content-insertion module that allows a hot-spot owner to insert specific content in wireless messages. The inserted content can be internet version of the commonly seen “bumber sticker” messages. It can also be commercial in nature.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a content insertion module separate from wireless modem;

FIG. 2 is a content insertion module integrated into a wireless modem; and

FIG. 3 is an HTML page modified by inserting FRAME elements.

For purposes of clarity and brevity, like elements and components will bear the same designations and numbering throughout the Figures.

### DESCRIPTION OF THE PREFERRED EMBODIMENT

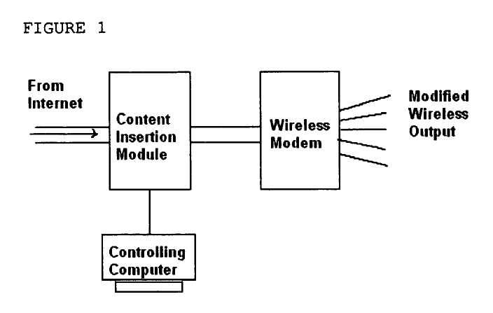

FIG. 1 shows Content Insertion Module 10 that receives Internet data and inserts specific content into it. The modified data is then given to the wireless modem 14 for distribution.

The Content Insertion Module 10 (called CIM below) will typically be connected to a Controlling Computer 12 for specifying, changing or deleting the content to be inserted.

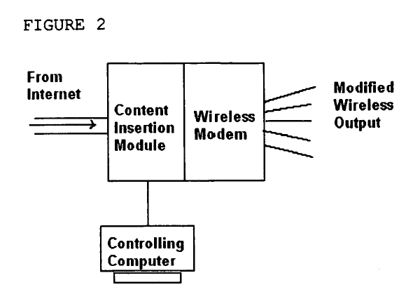

The CIM will be between the Input from Internet 18 and the outgoing Modified Wireless Output 16 data, but in some configurations it may be a part of the wireless modem 14 itself, as shown in FIG. 2. In other configurations, it may be a component of the controlling computer 12.

The CIM has the job of altering incoming internet data. The primary target is the HTTP protocol. The intent is to show advertisements or other messages from the owner of the CIM, alongside the data from the internet.

To achieve this, the CIM monitors port 80, as well as other ports (since HTTP can also utilize other ports) to detect the start of the HTTP protocol. Upon detecting the HTTP initial header, the CIM analyzes the entire content, and looks for HTML or XML tags.

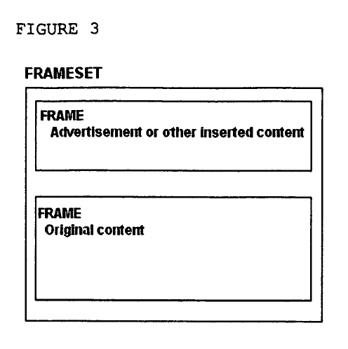

As shown in FIG. 3, the CIM adds an extra frame around the data, and along the margin of the data, adds the advertisement or other message from the CIM owner. Alternatively, the CIM can also analyze the entire page and suitably insert a table or image with the message. In general the frame method will be easier to work with since all modern browsers support framesets and since this involves no analysis of the HTML itself. Therefore it is the preferred recommended method.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A wireless distribution-point content insertion for allowing wireless distribution-point owners to insert content, comprising:
means for providing the content to be inserted and turning content insertion on or off.
means for inserting additional content into the incoming internet content and forwarding the result to the wireless modem; and

2. A wireless distribution-point content insertion in accordance with claim 1, wherein said means for providing the content to be inserted and turning content insertion on or off comprises a controlling computer.

3. A wireless distribution-point content insertion for a method for allowing wireless distribution-point owners to insert content, comprising:
a content insertion module, for inserting additional content into the incoming internet content and forwarding the result to the wireless modem; and
a controlling computer, for providing the content to be inserted and turning content insertion on or off.

4. A wireless distribution-point content insertion in accordance with claim 3, wherein the content insertion module inserts one or more HTML FRAME elements.

5. A wireless distribution-point content insertion in accordance with claim 3, wherein the content insertion module inserts text, table or figure elements.

6. A wireless distribution-point content insertion in accordance with claim 3, wherein the content insertion module is or can be integrated into the wireless model.

7. A wireless distribution-point content insertion in accordance with claim 3, wherein the content insertion module is or can be integrated into the controlling computer.
